(19) United States
(12) Patent Application Publication
(10) Pub. No.: US 2009/0084926 A1
(43) Pub. Date: Apr. 2, 2009

(54) SUPPORT FOR A BICYCLE FRONT GEARSHIFT AND A BICYCLE FRONT GEARSHIFT COMPRISING SUCH A SUPPORT

(75) Inventor: Paolo Pasqua, Camisano Vicentino (IT)

Correspondence Address: VOLPE AND KOENIG, P.C., UNITED PLAZA, SUITE 1600, 30 SOUTH 17TH STREET, PHILADELPHIA, PA, 19103, US

(73) Assignee: CAMPAGNOLO S.R.L., Vicenza (IT)

(21) Appl. No.: 12/212,281

(22) Filed: Sep. 17, 2008

(30) Foreign Application Priority Data
Sep. 28, 2007 (IT) MI2007A001871

(51) Int. Cl. G05G 11/00; F16M 13/00; B23P 15/14

(52) U.S. Cl. 248/647; 74/479.01; 29/893.1

(57) ABSTRACT

A bicycle gearshift support (22) including an anchoring (32) and a coupling (34) portion that are structurally distinct from each other and joined by a connector is disclosed. The invention is particularly well suited for a bicycle front gearshift (20), and the structurally distinct elements can be made from different materials.

### FIELD OF INVENTION

The following description relates to a support for a bicycle front gearshift.

The description also relates to a bicycle front gearshift including such a support and a bicycle including the aforementioned front gearshift. Preferably, the bicycle is a racing bicycle.

Furthermore, the description relates to a method for manufacturing a support for a bicycle front gearshift.

### BACKGROUND

A bicycle is a mechanical vehicle moved by muscular driving force that is transmitted to a rear driving wheel through a motion transmission system. The motion transmission system includes a pair of crank arms, on which the cyclist exerts a propulsive thrust, one or more driving sprockets, rotated by direct coupling with the crank arms, and one or more driven sprockets, rotated by the driving sprockets through a chain, the driven sprockets being coupled with the hub of the rear wheel.

In particular, racing bicycles include a plurality of driven sprockets of various diameters and a plurality of driving sprockets, also of various diameters. The chain simultaneously engages a driving and a driven sprocket and is selectively movable over them through a gearshift device, so as to obtain the combination of a particular driving and driven sprocket that offers the most favorable transmission ratio for the conditions of the route.

The bicycle typically includes a front gearshift, which moves the chain from one driving sprocket to another, and a rear gearshift, which moves the chain from one driven sprocket to another.

In the prior art, the front gearshift includes a chain guide that surrounds the chain to exert the necessary thrust thereon in order to move it, a support to fasten the front gearshift to the seat post tube of the bicycle frame, and two articulation arms to movably connect the chain guide to the support. The chain guide, the support and the two articulation arms define an articulated quadrilateral that allows the chain to be moved on the sprockets.

### SUMMARY

The disclosed support for a bicycle gearshift includes an anchoring portion and a coupling portion. The anchoring portion is configured to anchor the support to an element of a bicycle frame. The coupling portion is distinct from the anchoring portion, and is configured to couple the support with a driving member of a bicycle chain.

A method for manufacturing such a support includes the steps of making the anchoring portion, making the coupling portion, and rigidly associating the coupling portion and the anchoring portion with each other.

### BRIEF DESCRIPTION OF THE DRAWINGS

FIG. 1 schematically shows a perspective view of a bicycle front gearshift of the prior art;

FIG. 2 schematically shows an exploded perspective view of a bicycle front gearshift comprising a support according to a first embodiment of the gearshift;

FIG. 3 schematically shows an exploded perspective view of a second embodiment of a support for a bicycle front gearshift;

FIG. 4 schematically shows a perspective view of a bicycle front gearshift comprising a support according to a third embodiment;

FIG. 5 schematically shows an exploded perspective view of the support of FIG. 4;

FIGS. 6 and 7 schematically show perspective views, according to different angles, of the support of FIG. 4;

FIG. 8 schematically shows a front view of the support of FIG. 4 mounted on a tube of a bicycle frame near to a rear wheel in normal working conditions;

FIG. 9 schematically shows a plan view from above of the support of FIG. 4.

### DETAILED DESCRIPTION OF THE PREFERRED EMBODIMENT(S)

### Introduction to the Embodiments

The support for a bicycle front gearshift includes an anchoring portion for anchoring to a seat post tube of a bicycle and a coupling portion for coupling with a driving member of a bicycle chain. The anchoring portion is structurally distinct from the coupling portion.

Throughout the present description and in the subsequent claims, the expression “structurally distinct” used with reference to the anchoring portion and with respect to the coupling portion, or vice-versa, is used to indicate that the two portions are defined at respective elements obtained separately with distinct methods of manufacturing, such elements thus being able to be made from the same material or from two different materials.

In the support for the bicycle front gearshift, the anchoring portion and the coupling portion, which are distinct in function, shape, thickness and tensional stress, can be better designed in relation to their specific function, so avoiding the risk of loosening.

In a first embodiment of the support, the coupling portion is removably associated with the anchoring portion, for example through rigid connecting elements such as pins, screws, bolts, rivets or other connecting elements known to a person of ordinary skill in the art. In this case, the aforementioned connecting elements are housed in respective holes, aligned with each other, formed in the anchoring portion and in the coupling portion.

In a second embodiment of the support, the coupling portion is permanently associated with the anchoring portion, such as by gluing, co-molding, caulking (riveting) or other processes known to a person of ordinary skill in the art.

Irrespective of the coupling method between coupling portion and anchoring portion of the support, the anchoring portion preferably has a substantially annular shape. Such an anchoring portion preferably includes two first ends that can be coupled together through at least one bolt or screw to obtain clamping of the anchoring portion around the seat post tube of a bicycle.

In a first preferred embodiment of the support, the anchoring portion includes a pair of jaws that are structurally distinct from each other, each jaw including one of the aforementioned first ends and being associated with the other jaw at a respective second end opposite the first end.

In this case the aforementioned coupling portion is preferably associated with at least one first jaw of the aforementioned pair of jaws.

In a second preferred embodiment of the support, the anchoring portion includes a single jaw defining an elastic monolithic clip.

Irrespective of the specific embodiment of the anchoring portion of the support, it includes at least one connecting part for connecting to the coupling portion, which is housed in a groove formed in the coupling portion.

Clearances are thus avoided between the anchoring portion and the coupling portion, improving the precision of gearshifting.

Preferably, the anchoring portion includes a part that, when the support is mounted on the seat post tube of the bicycle, faces towards the rear wheel of the bicycle and is lower than the remainder of the anchoring portion.

Such a support is particularly advantageous when applied to bicycle seat post tubes that are positioned close to the rear wheel of the bicycle. This is because the lowest part of the anchoring portion, i.e. the part intended to face towards the rear wheel of the bicycle, is positioned lower (and therefore in the area in which the rear wheel diverges from the seat post tube) than where it would be positioned if the anchoring portion extended entirely in a plane substantially perpendicular to the axis of the seat post tube.

The connecting part is preferably defined in the part of the anchoring portion intended to face towards the rear wheel of the bicycle, and the aforementioned groove has two end portions arranged at different heights so that, when the support is mounted on the seat post tube of the bicycle, an end portion of the groove facing towards the rear wheel of the bicycle is lower than the other end portion of such a groove.

In one embodiment of the support, the connecting part is held in the groove through pins and gluing, so as to create a particularly stable coupling.

In the case in which the support is intended to be used in a motorized gearshift, the coupling portion includes a seat for housing a worm screw.

In this embodiment, the advantages of decrease in residual tensions in the anchoring portion due to the simplicity of manufacturing are particularly evident, since in a motorized gearshift the coupling portion is an inevitably large and complex piece. In contrast, the supports of the prior art generally have a thin section at the connection of such a coupling portion with the anchoring portion.

The coupling portion is preferably made from composite material, and more preferably from reinforced composite material.

The coupling portion made in this way can be easily manufactured by injection molding and possibly machined with a machine tool, in order to obtain complex shapes while keeping a low weight and high degree of structural strength.

Preferably, the anchoring portion is at least partially made from a material having a linear thermal expansion coefficient lower than or equal to 5·10⁻⁵ m/m-K.

More preferably, at least the connecting part for connecting the anchoring portion to the coupling portion is made from the material with a thermal expansion coefficient lower than or equal to 5·10⁻⁵ m/m-K.

This makes it practically certain that the anchoring portion, even if subjected to high temperatures (for example because the bicycle is left in the trunk of a car under the sun), will not undergo stretching, due to thermal expansion, of more than two tenths of a millimeter, so that it will not loosen.

Preferably, such a material is a metallic material.

Use of a metallic material permits compromise between cost-effectiveness of manufacturing and linear thermal expansion control, which is of the order of 5·10⁻⁶ m/m-K.

In one preferred embodiment of the support, the entire anchoring portion is made from metallic material.

Alternatively, the material of the anchoring portion, or of only the connecting part of the anchoring portion, is a structural composite material.

Such a material has a thermal expansion coefficient lower than that of the metal and on the order of 5·10⁻⁷ m/m-K, which limits deformation by tension to a negligible amount, even if the anchoring portion is put under a high temperature.

The disclosure also relates to a bicycle front gearshift including a support and a chain guide for moving a bicycle chain, connected to each other by at least two articulation arms, the support being of the type described above.

Preferably, such a bicycle front gearshift has, individually or in combination, all of the structural and functional characteristics discussed above with reference to the aforementioned support for a bicycle front gearshift, therefore having all of the aforementioned advantages.

The disclosure also relates to a bicycle including a front gearshift of the type described above.

Such a bicycle preferably has, individually or in combination, all of the structural and functional characteristics discussed above with reference to the aforementioned front gearshift, therefore having all of the aforementioned advantages.

The disclosure further relates to a method of manufacturing a support for a bicycle front gearshift that includes an anchoring portion for anchoring to a seat post tube of a bicycle and a coupling portion with a driving member for driving of a bicycle chain. The method includes the following steps of:

making the anchoring portion,

making the coupling portion,

rigidly associating the coupling portion and the anchoring portion with each other.

This method allows the aforementioned advantages to be obtained. In particular, with this method, the anchoring portion and the coupling portion can be manufactured separately. They can thus be better designed according to their specific functions, having a simpler shape and higher strength than the respective portions of the supports of the prior art.

The coupling portion can be removably associated with the anchoring portion, such as through pins, screws, bolts, rivets, or other connecting elements known to a person of ordinary skill in the art, or can be permanently associated with the anchoring portion, such as through gluing, co-molding, caulking (riveting), or other processes known to a person of ordinary skill in the art.

Further characteristics and advantages of the embodiments shall become clearer from the following detailed description of preferred embodiments, made with reference to the attached drawings and given for indicating and not limiting purposes.

### DETAILED DESCRIPTION

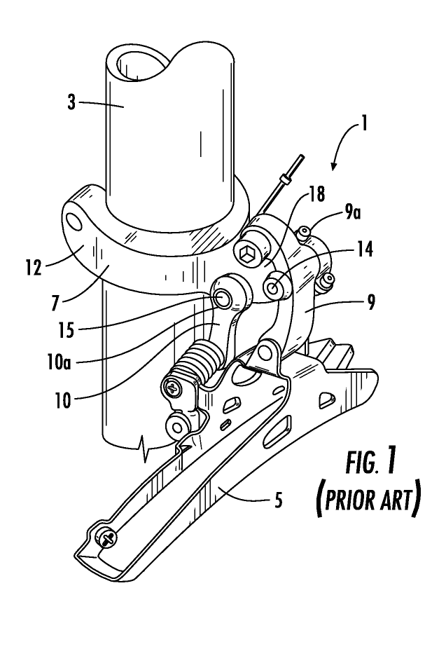

FIG. 1 shows a front gearshift of the prior art, indicated with 1, fastened to a seat post tube 3 of a bicycle. As shown, chain guide 5 and a support 7 are easily distinguishable, and are connected by two articulation arms 9 and 10.

The support 7 surrounds a seat post tube 3 of the bicycle frame through a clip portion 12. The support 7 houses two articulation pins 14 and 15. Respective ends 9a and 10a of the articulation arms 9 and 10 are rotatably mounted about such pins. The pins 14 and 15 are associated with a portion 18 of the support 7, which is formed as a single piece with the clip portion 12 and extends in a canti-levered fashion from the clip portion 12.

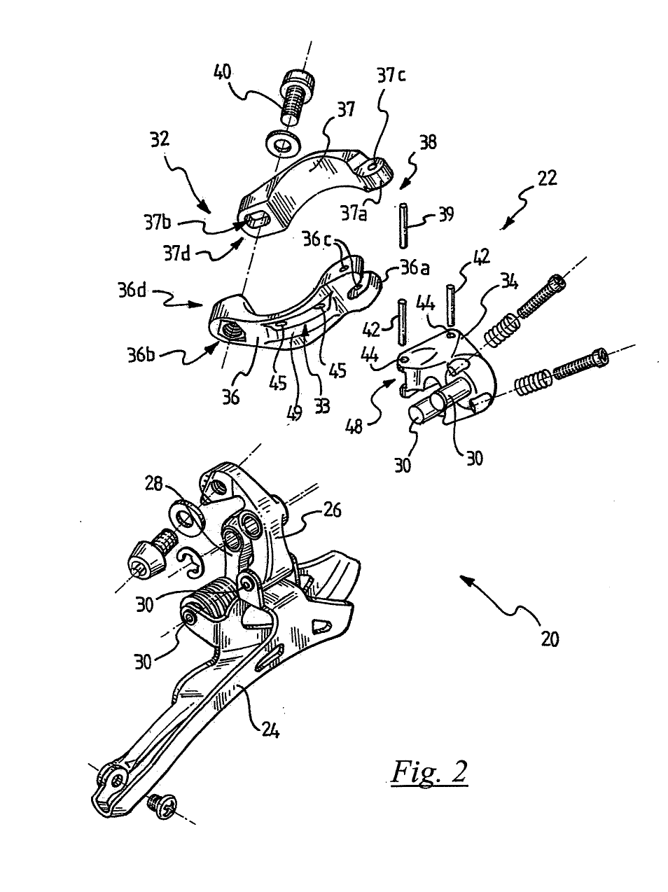

With initial reference to FIG. 2, a first embodiment of a support 22 for a bicycle front gearshift 20 is shown.

The front gearshift 20 comprises the support 22 itself, which is configured to fasten the gearshift 20 to the frame of a bicycle (in particular to the seat post tube of the bicycle, indicated with 3 in the FIG. 1, relative to the prior art), a cage or driving member 24 of the bicycle chain, such as a chain guide (the chain is not shown since it is per se conventional), intended to engage and move the chain, a front articulation arm 26 and a rear articulation arm 28, with respect to which the terms front and rear refer to the configuration in which the support is mounted on the bicycle. The two articulation arms 26 and 28 connect the chain guide 24 to the support 22 by way of four pins 30, thus defining an articulated quadrilateral.

The support 22 comprises an anchoring portion 32 for anchoring to the seat post tube 3 of the bicycle and a coupling portion 34 for coupling with the articulation arms 26 and 28, the portions 32 and 34 being structurally distinct from each other.

The anchoring portion 32, in use, is intended to surround the seat post tube 3 of the bicycle and comprises a pair of jaws 36 and 37 joined at one of each of their ends by a hinge 38, and at the opposite ends by a lock screw 40.

One of the jaws 37 has a cap-shaped end 37a that is inserted into a forked end 36a of the other jaw 36. The ends 37a and 36a have respective through holes 37c and 36c (one hole 37c on the end 37a and two holes 36c on the end 36a), which are aligned for the insertion of a rotation pin 39. Jaw 37 has, at the end 37d opposite the end 37a, an opening 37b through which a screw 40 passes, whereas jaw 36 has, at the end 36d opposite the end 36a, a threaded hole 36b in which the screw 40 engages. Alternatively, the screw 40 can pass through a hole in jaw 36 having no threading, being fastened in place by a nut (not illustrated).

The coupling portion 34 is permanently associated with at least one of the articulation pins 30, such as by co-molding or gluing, and comprises a seat for a second articulation pin 30. Alternatively, both of the pins 30 can be permanently or removably associated with the coupling portion 34.

The anchoring portion 32 is removably associated with the coupling portion 34, in the example illustrated in FIG. 2, through rigid connecting elements such as a pair of pins 42 that are inserted through holes 44 of the coupling portion 34 and further through holes 45 of jaw 36, aligned with the holes 44 of the coupling portion 34.

In order to totally eliminate the clearance between the anchoring portion 32 and the coupling portion 34, in addition to providing a connection through pins 42, it is also possible to glue together the two portions 32 and 34 at a connecting part 33, formed in the anchoring portion 32. Such a connecting part 33, in the example illustrated in FIG. 2, is defined by a rib 49.

The coupling portion 34 comprises a groove 48 in which the rib 49 is inserted. The aligned holes 44 and 45 extend through the walls of the groove 48 and through the rib 49.

The connection between the anchoring portion 32 and the coupling portion 34 just described and illustrated in FIG. 2 is given purely as an example; a person of ordinary skill in the art would understand that any type of connection that creates a rigid coupling is suitable. For example, it is possible to create a removable connection through pins, screws, bolts, rivets or other connecting elements known to a person of ordinary skill in the art, or an irremovable connection through gluing, co-molding, caulking (riveting) or other processes known to a person of ordinary skill in the art.

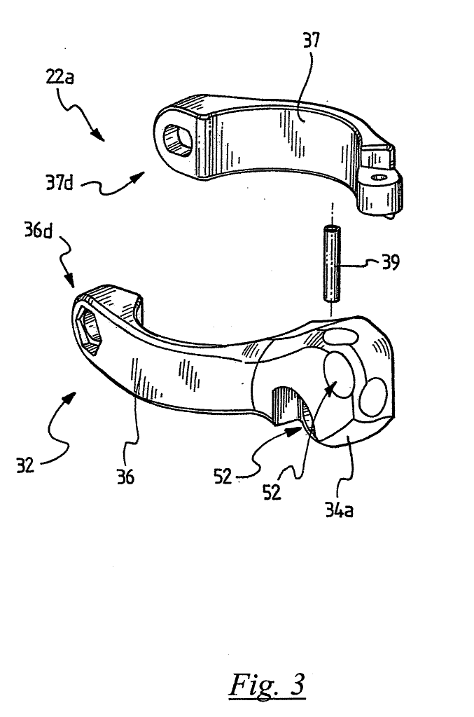

FIG. 3 shows a second embodiment of the support, which is indicated with 22a. In FIG. 3, structural elements that are identical or equivalent from the functional point of view to those of the support 22 described above with reference to FIG. 2 shall be indicated with the same reference numerals and will not be described any further.

In particular, the support 22a differs from the support 22 of FIG. 2 substantially in that the jaw 36 is associated with the coupling portion 34a through co-molding. In FIG. 3, through holes 52 formed in the coupling portion 34a for the insertion of a pair of articulation pins 30 (not illustrated) are also shown.

According to another embodiment of the support, not illustrated, the jaws 36 and 37 of the anchoring portion 32 of the support 22 of FIG. 2 are integrally joined together at one end and engaged by a lock screw at the opposite end. In this case, the two jaws 36 and 37 of the anchoring portion 32 of FIG. 2 form a single jaw defining an elastic monolithic clip, which has a substantially annular shape. Such a clip is divided at a sector thereof so as to define two ends that can be coupled together.

The anchoring portion 32 and the coupling portion 34 can be made with any suitable material, such as an aluminum alloy, a composite material or a polymer.

By composite material, what is meant is a material consisting of at least two components including a polymeric matrix and a filler, such as structural fibers, granules or powders. The structural fibers are preferably selected from the group consisting of carbon fibers, glass fibers, aramid fibers, ceramic fibers, boron fibers, and combinations thereof. Carbon fibers are particularly preferred. Preferably, the polymeric material is thermosetting and comprises an epoxy resin. However, the use of a thermoplastic material is not excluded.

By structural composite materials what is meant is a material containing structural fibers having a length of over five millimeters. The arrangement of the structural fibers in the polymeric material can be a random arrangement, or small sheets of structural fibers, a substantially unidirectional ordered arrangement of fibers, a substantially bidirectional ordered arrangement of fibers, or a combination of the above.

By reinforced composite material, on the other hand, what is meant is a material comprising a polymeric matrix filled with fibers of a length less than or equal to five millimeters and/or with powders and/or with granules. It should be observed that the dimensions shown refer to the length of the fiber that can be found in a finished piece.

Reinforced composite materials have a structural strength lower than that of composite structural materials, but are generally suitable for injection molding and are easy to work, which is why they are particularly preferred for manufacturing the coupling portion 34, to which they also help to minimize the weight of. However, for such a coupling, portion the use of a simple polymer is not excluded.

Composite structural materials have a high structural strength and a very low linear thermal expansion coefficient, in general of the order of 5·10⁻⁷ m/m-K. For this reason they are particularly preferable for manufacturing the anchoring portion 32, or at least one of the two jaws 36 and 37 of FIGS. 2 and 3.

A less expensive alternative is to manufacture the anchoring portion 32, or at least a part thereof, such as the jaw 36 of FIGS. 2 and 3, from metal, such as an aluminum alloy and/or magnesium, both of which have a linear thermal expansion coefficient of the order of 5·10⁻⁶ m/m-K. In general, materials having a linear thermal expansion coefficient lower than 5·10⁻⁵ mn/m-K are preferably used for manufacturing of the anchoring portion 32.

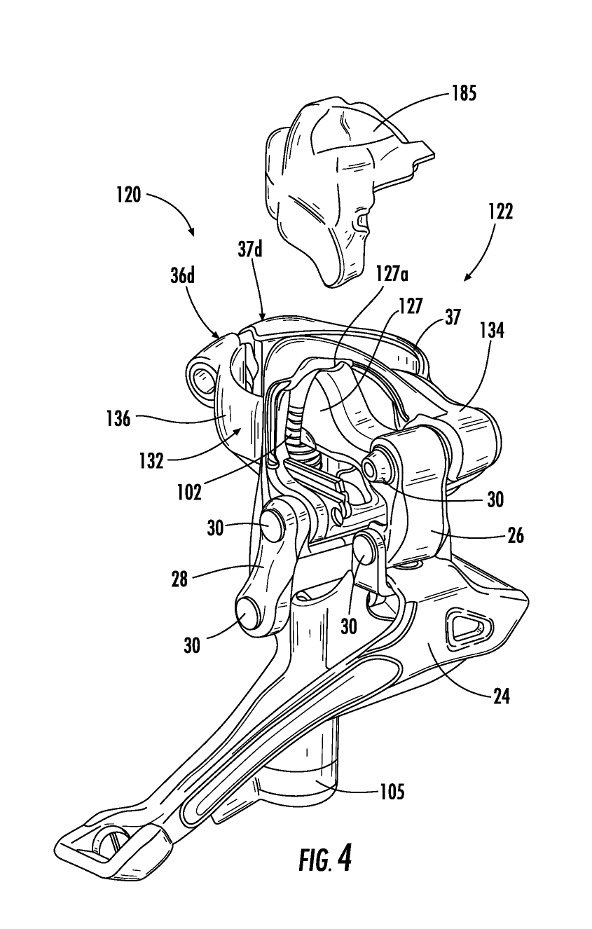

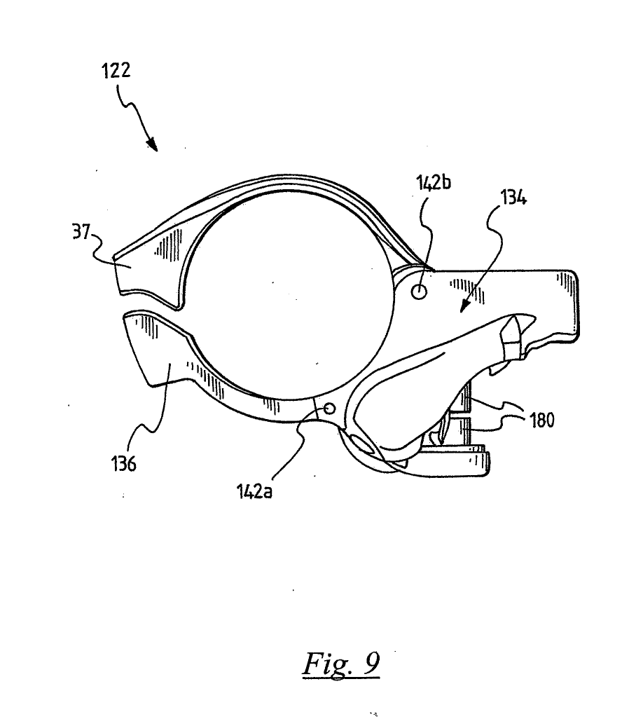

FIGS. 4-9 show a third embodiment of the support, which is indicated with 122. The support 122 is part of a bicycle front gearshift 120. The front gearshift 120 shown is a motorized gearshift, of the type similar to that which is described in issued U.S. Pat. No. 6,679,797, to the same Applicant.

In FIG. 4, structural elements that are identical or equivalent from the functional point of view to those of the gearshift 20 described above with reference to FIG. 2 are indicated with the same reference numerals and they are not be described any further.

The gearshift 120 comprises a support 122 comprising an anchoring portion 132, substantially identical to the anchoring portion 32 of FIG. 2, and a coupling portion 134. The portions 132 and 134 are structurally distinct from each other.

The main difference with respect to the gearshift 20 of FIG. 2 is the fact that the coupling portion 134 has a more complex shape than that of the coupling portion 34 of FIG. 2 and is adapted to house a worm screw 102, actuated by an electric motor 105.

A chain guide 24 is connected to the coupling portion 134 through the front articulation arm 26 and the rear articulation arm 28, which are rotatable about the pins 30, in a similar manner to that which has been described above with reference to the gearshift 20 of FIG. 2.

The front articulation arm 26 has an extension 127 terminating with an engagement portion 127a, carrying a nut, which engages with the worm screw 102. When the worm screw 102, actuated by the electric motor 105, moves the engagement portion 127a of the extension 127, the arm 26 rotates about a pin 30 that is fixed with respect to the coupling portion 134, causing the movement of the chain guide 24.

What has been stated above with respect to the connection and to the materials used for the anchoring portion 32 and the coupling portion 34 of FIG. 2 is also applicable to the corresponding anchoring and coupling portions 132, 134 of FIG. 4.

In this case, in addition to the advantages listed above is the fact that the support 122, which comprises the coupling portion 134 having a per se complex shape, can be more easily molded than the support for a front gearshift illustrated in issued U.S. Pat. No. 6,679,797 to the same Applicant, since the coupling portion 134 is produced separately from the anchoring portion 132.

Moreover, the residual tensions inside the coupling portion 134 are lower, since there are no long portions having thin sections (such as the anchoring portion 132) connected roughly to thicker portions (such as the coupling portion 134). As a result, the cooling of the pieces (in particular of the coupling portions 134) in the mold is substantially uniform and the residual tensions are minimized. This allows even pieces having a particularly complicated shape to be molded (in particular coupling portions 134).

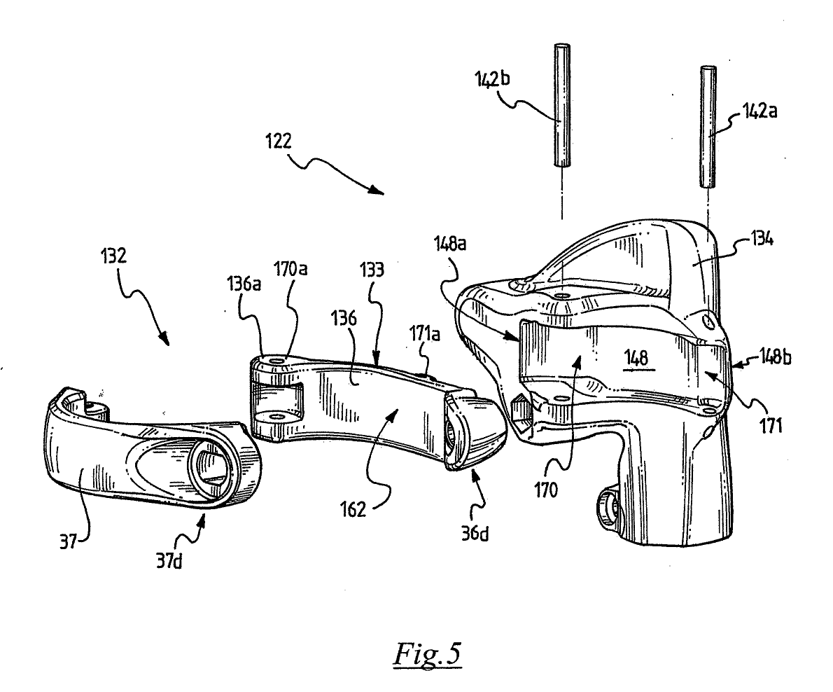

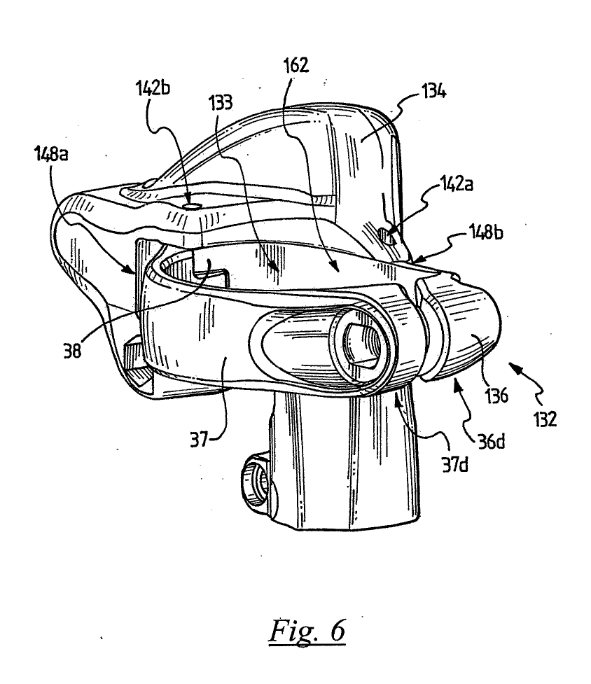

As illustrated in FIGS. 5 and 6, the support 122 comprises a groove 148 of a shape suitable for receiving a connecting part 133 of a jaw 136.

Two pins 142a and 142b traverse the entire height of the connecting part 133 of the jaw 136. The groove 148 comprises two deepened end areas 170 and 171 in proximity to the passing points of the pins 142a and 142b, so as to house corresponding areas of increased width 170a and 171a, projecting outside from the jaw 136.

A fork-shaped end 136a of the jaw 136 is totally housed in the deepened end area 170 and held in place by the pin 142b, which acts as an articulation pin between the jaw 136 and the jaw 37, thus replacing the function of the pin 39 of the support 22 of FIG. 2. For this reason the pin 142b preferably has a larger diameter than the pin 142a.

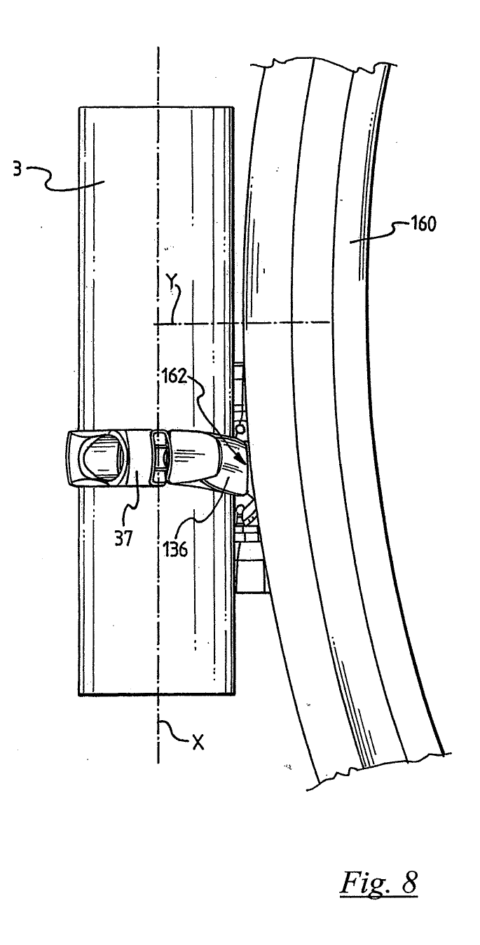

In FIGS. 5, 6 and 8 it can also be seen that the support 122 is skewed when mounted on the seat post tube 3 of the bicycle; i.e. it has at least one part 162 with inclined extension (downwards) with respect to the extension of the remaining part of the jaw 136 and of the other jaw 37 which, in contrast, substantially follows a plane perpendicular to the axis X of the seat post tube 3 of the bicycle on which the support 122 is mounted, as shown in FIG. 8.

Moreover, FIG. 8 shows that the anchoring portion 132 is mounted on the seat post tube 3 of the bicycle with the jaw 136 facing towards the rear wheel 160 of the bicycle.

In particular, the jaw 136 has a descending progression at the inclined portion 162 that, in use, is intended to face the rear wheel 160 of the bicycle. Due to this provision, the inclined portion 162 of jaw 136 that faces the rear wheel 160 remains further away, with respect to the remainder of the anchoring portion 132, from plane Y, which is perpendicular to the axis X and at which the distance between the wheel 160 and the seat post tube 3 of the bicycle is at its minimum.

This is particularly advantageous when the support 122 is to be applied to a seat post tube 3 that is very close to the rear wheel 160. Since the position of the support on the seat post tube is dictated by the position that the chain guide must take up with respect to the sprockets, if the jaw 136 lacked the aforementioned inclined portion 162 and lied substantially in the same plane perpendicular to the axis X in which the jaw 37 extends, the anchoring portion 132, given the thickness of the jaws, would run the risk of interfering with the rear wheel of the bicycle. In contrast, configuring the jaw 136 such that it is skewed in the aforementioned manner, the inclined portion 162 is further away from the rear wheel 160.

The connecting part 133 is defined in the inclined portion 162 of the jaw 136, and is housed in the groove 148, which also has a skewed configuration. In other words, when the support 122 is mounted on the seat post tube 3 of the bicycle, the groove 148 is substantially inclined with respect to a plane perpendicular to the axis X of the seat post tube 3.

In FIG. 5 it can be seen how the openings 148a and 148b of the coupling portion 134, arranged at the opposite end portions of the groove 148 and from where the jaw 136 projects when mounted on the coupling portion 134, are not aligned with respect to a plane perpendicular to the axis X of the seat post tube 3, but are at different heights, so that the end portion 148b of the groove 148 facing towards the rear wheel 160 of the bicycle is lower than the other end portion 148a of the groove 148.

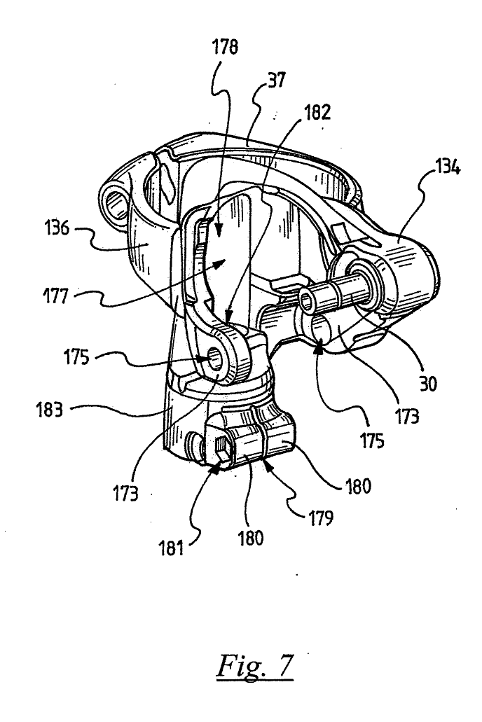

FIG. 7 shows the coupling portion 134 according to a different perspective than that of FIG. 6. It should be noted that the pin 30 is integrated with the coupling portion 134, such as through co-molding. The pin 30 is intended to couple with the front articulation arm 26.

The coupling portion 134 also comprises a pair of plates 173 facing each other so as to form a chain guide, and on which a respective hole 175 is formed, the holes 175 being aligned with each other for the passage of the other pin 30, intended to couple with the rear articulation arm 28.

The coupling portion 134 is hollow so as to define a housing seat 177 for the worm screw 102. Such a seat 177 has a top opening 178, for the access of the extension 127 of the front articulation arm 26. A cover 185 (FIG. 4), fixedly fitted along the edge of the opening 178, protects the worm screw 102 and the engagement portion 127a of the extension 127 of the front articulation arm 26.

The housing seat 177 is in communication with a tubular space 182 coaxial thereto and formed in a part 183 of the coupling portion 134, adapted to be coupled with an end of the electric motor 105 (FIG. 4).

The part 183 of the coupling portion 134 for receiving an end of the motor 105 comprises an elastic clip 179, produced by forming two wings 180 which are elastically deformable and integral with the coupling portion 134. The wings 180 are crossed by respective holes 181 which are aligned with each other for the passage of a bolt or locking screw (not shown).

The assembly of the support for the bicycle front gearshift takes place in the following way. The anchoring portion (32 in FIGS. 2 and 3, 132 in FIG. 4) is opened by rotating the jaws (36 and 37 in FIGS. 2 and 3, 136 and 37 in FIG. 4) about the rotation pin 39 (FIGS. 2 and 3) or the pin 142b (FIG. 5) of the hinge (38 in FIGS. 2 and 6). It is thus possible to arrange the anchoring portion (32 in FIGS. 2 and 3, 132 in FIG. 4) around the seat post tube 3 of the bicycle. At this point, the jaws (36 and 37 in FIGS. 2 and 3, 136 and 37 in FIG. 4) are closed by rotating them about the rotation pin 39 (FIGS. 2 and 3) or the pin 142b (FIG. 5), and are clamped around the seat post tube 3 by the screw 40.

In the embodiment in which the anchoring portion comprises a monolithic clip, such a clip is elastic, so that the two attachable ends can be separated to allow arrangement of the clip about the seat post tube of the bicycle. Once the clip has elastically returned to its original position, the attachable ends are attached using a locking screw, until the clamping of the anchoring portion around the seat post tube is obtained.

In the case of a motorized gearshift, the clip 179 is clamped around the electric motor 105 and keeps it in operative connection with the worm screw 102 inserted in the housing seat 177, for example through an Oldham joint (not illustrated), housed in the tubular space 182 of the housing seat 177.

A person of ordinary skill in the art could envision numerous modifications and variants with respect the support for the bicycle front gearshift and to the front gearshift described above, in order to satisfy specific and contingent requirements.

What is claimed is:

1. A support (22, 22a, 122) for a bicycle front gearshift (20, 120), comprising an anchoring portion (32, 132) for anchoring to a seat post tube (3) of a bicycle, and a coupling portion (34, 34a, 134) for coupling with a driving member (24) of a bicycle chain, wherein the anchoring portion (32, 132) is structurally distinct from the coupling portion (34, 34a, 134).

2. The support (22, 122) of claim 1 wherein the coupling portion (34, 134) is removably associated with the anchoring portion (32, 132).

3. The support (22, 122) of claim 2 wherein the coupling portion (34, 134) is associated with the anchoring portion (32, 132) through rigid connecting elements selected from the group consisting of pins (42, 142a, 142b), screws, bolts and rivets, the connecting elements being housed in respective holes (44, 45), aligned with each other, formed in the anchoring portion (32, 132) and in the coupling portion (34, 134).

4. The support (22, 22a, 122) of claim 1 wherein the coupling portion (34, 34a, 134) is irremovably associated with the anchoring portion (32, 132).

5. The support (22, 22a, 122) according to claim 4 wherein the coupling portion (34, 34a, 134) is associated with the anchoring portion (32, 132) through gluing.

6. The support (22a) of claim 4 wherein the coupling portion (34a) is associated with the anchoring portion (32) through co-molding.

7. The support (22, 22a, 122) of claim 4 wherein the coupling portion (34, 34a, 134) is associated with the anchoring portion (32, 132) through riveting.

8. The support (22, 22a, 122) of claim 1 wherein the anchoring portion (32, 132) has a substantially annular shape.

9. The support (22, 22a, 122) of claim 8 wherein the anchoring portion (32, 132) comprises two first ends (36d, 37d) that can be coupled with each other through at least one bolt or screw (40) to obtain the clamping of the anchoring portion (32, 132) around the seat post tube (3) of the bicycle.

10. The support (22, 22a, 122) of claim 9 wherein the anchoring portion (32, 132) comprises a pair of structurally distinct jaws (36, 37, 136), each jaw (36, 37, 136) comprises one of the first ends (36d, 37d) and being associated with the other jaw (36, 37, 136) at a respective second end (36a, 37a, 136a) opposite the first end (36d, 37d, 136d).

11. The support (22, 22a, 122) of claim 10 wherein the coupling portion (34, 34a, 134) is associated with at least one first jaw (36, 136) of the pair of jaws (36, 37, 136).

12. The support of claim 9 wherein the anchoring portion comprises a single jaw defining an elastic monolithic clip.

13. The support (122) of claim 1 wherein the anchoring portion (132) comprises a part (162) that, when the support (122) is mounted on the seat post tube (3) of the bicycle, faces towards a rear wheel (160) of the bicycle and is lower than the remaining part of the anchoring portion (132).

14. The support (22, 122) of claim 1 wherein the anchoring portion (32, 132) comprises at least one connecting part (33, 133) for connecting to the coupling portion (34, 134), the connecting part being housed in a groove (48, 148) formed in the coupling portion (34, 134).

15. The support (122) of claim 13 wherein the anchoring portion (32, 132) comprises at least one connecting part (33, 133) for connecting to the coupling portion (34, 134), the connecting part being housed in a groove (48, 148) formed in the coupling portion, and the at least one connecting part (133) is defined in the part (162) intended to face towards the rear wheel (160) of the bicycle and wherein the groove (148) has end portions arranged at different heights so that, when the support (122) is mounted on the seat post tube (3) of the bicycle, an end portion (148b) of the groove (148) facing towards the rear wheel (160) of the bicycle is lower than the other end portion (148a) of the groove (148).

16. The support (122) of claim 14 wherein the connecting part (133) is held in the groove (148) through pins (142a, 142b) and gluing.

17. The support (122) of claim 1 wherein the coupling portion (134) comprises a seat (177) for housing a worm screw (102) for a motorized gearshift.

18. The support (22, 22a, 122) of claim 1 wherein at least one of the anchoring portion (32, 132) or coupling portion (34, 34a, 134) is made from composite material.

19. The support (22, 22a, 122) of claim 18 wherein the coupling portion (34, 34a, 134) is made from reinforced composite material.

20. The support (22, 22a, 122) of claim 1 wherein the anchoring portion (32, 132) is at least partially made from a material with a linear thermal expansion coefficient less than or equal to 5·10⁻⁵ m/m-K.

21. The support (22, 122) of claim 14 wherein at least the connecting part (33, 133) of the anchoring portion (32, 132) is made from a material with thermal expansion coefficient lower than or equal to 5·10⁻⁵ m/m-K.

22. The support (22, 22a, 122) of claim 20 wherein the material is a metallic material.

23. The support (22, 22a, 122) of claim 20 wherein the material is a structural composite material.

24. A bicycle front gearshift (20, 120), comprising a support (22, 22a, 122) and a driving member (24) for driving a bicycle chain, connected to each other by at least two articulation arms (26, 28), wherein the support (22, 22a, 122) comprises an anchoring portion (32, 132) for anchoring to a seat post tube (3) of a bicycle, and a coupling portion (34, 34a, 134) for coupling with a driving member (24) of a bicycle chain, wherein the anchoring portion (32, 132) is structurally distinct from the coupling portion (34, 34a, 134).

25. A bicycle comprising a front gearshift (20, 120) comprising a support (22, 22a, 122) and a driving member (24) for driving a bicycle chain, connected to each other by at least two articulation arms (26, 28), wherein the support (22, 22a, 122) comprises an anchoring portion (32, 132) for anchoring to a seat post tube (3) of a bicycle, and a coupling portion (34, 34a, 134) for coupling with a driving member (24) of a bicycle chain, wherein the anchoring portion (32, 132) is structurally distinct from the coupling portion (34, 34a, 134).

26. A method for manufacturing a support (22, 22a, 122) for a bicycle front gearshift (20, 120), comprising an anchoring portion (32, 132) for anchoring to a seat post tube (3) of a bicycle and a coupling portion (34, 34a, 134) for coupling with a driving member (24) of a bicycle chain, comprising the following steps of:
making the anchoring portion (32, 132),
making the coupling portion (34, 34a, 134), and
rigidly associating the coupling portion (34, 34a, 134) and the anchoring portion (32, 132) with each other.

27. The method of claim 26 wherein the coupling portion (34, 134) is removably associated with the anchoring portion (32, 132).

28. The method of claim 27 wherein the coupling portion (34, 134) is associated with the anchoring portion (32, 132) through at least one of pins (42, 142a, 142b), screws, bolts or rivets.

29. The method of claim 26 wherein the coupling portion (34, 34a, 134) is permanently associated with the anchoring portion (32, 132).

30. The method of claim 29 wherein the coupling portion (34, 34a, 134) is associated with the anchoring portion (32, 132) through gluing.

31. The method of claim 29 wherein the coupling portion (34a) is associated with the anchoring portion (32) through co-molding.

32. The method of claim 29 wherein the coupling portion (34, 34a, 134) is associated with the anchoring portion (32, 132) through riveting.

33. A support (22, 22a, 122) for a bicycle gearshift (20, 120), comprising:
an anchoring portion (32, 132) configured to anchor the support to an element (3) of a bicycle frame; and
a coupling portion (34, 34a, 134), distinct from the anchoring portion, and configured to couple the support with a driving member (24) of a bicycle chain.

34. The support (22, 22a, 122) of claim 33 wherein in the coupling (34, 34a, 134) and anchoring portion (32, 132) are rigidly attached together.

35. A support (22, 22a, 122) for a bicycle front gearshift (20, 120), comprising:
an anchoring portion (32, 132) configured to anchor the support (22, 22a, 122) to a seat post tube (3) of a bicycle; and
a coupling portion (34, 34a, 134) configured to couple the support (22, 22a, 122) with a driving member (24) of a bicycle chain;
wherein the anchoring portion (32, 132) is structurally distinct from the coupling portion (34, 34a, 134); and
the coupling portion (34, 134) is removably attached to the anchoring portion (32, 132), by a connection formed by connecting elements comprising at least one of pins (42, 142a, 142b), screws, bolts, or rivets; and
the connecting elements are housed in respective aligned holes (44, 45), defined in the anchoring portion (32, 132) and the coupling portion (34, 134).

36. A support (22, 22a, 122) for a bicycle front gearshift (20, 120), comprising:
an anchoring portion (32, 132) configured to anchor the support (22, 22a, 122) to a seat post tube (3) of a bicycle; and
a coupling portion (34, 34a, 134) configured to couple the support (22, 22a, 122) with a cage (24) of a bicycle chain;
wherein the anchoring portion (32, 132) is structurally distinct from the coupling portion (34, 34a, 134); and
the anchoring portion (32, 132) comprises at least one connecting part (33, 133) that connects to the coupling portion (34, 134), the connecting part is configured to mate with a section (48, 148) of the coupling portion (34, 134).

37. The support (22, 22a, 122) of claim 36 wherein the connecting part comprises a rib (49) and the section (48, 148) of the coupling portion (34, 134) comprises a groove (48, 148).

38. A support (22, 22a, 122) for a motorized front gearshift (20, 120) of a bicycle, comprising:
an anchoring portion (32, 132) configured to anchor the support (22, 22a, 122) to a seat post tube (3) of a bicycle; and
a coupling portion (34, 34a, 134) configured to couple the support (22, 22a, 122) with a driving member (24) for actuating movement of a bicycle chain between different sprockets that drive the bicycle chain;
wherein coupling portion is structurally distinct from the anchoring portion (32, 132) and defines a seat (177) that houses a worm screw (102) driven by an electric motor (105) for actuating movement of the driving member.

39. The support (22, 22a, 122) of claim 38, further comprising a tubular region (182) configured for coupling with an end of the electric motor (105) coaxial with the seat (177).

40. A support (22, 22a, 122) for a bicycle front gearshift (20, 120), comprising:
an anchoring portion (32, 132) configured to anchor the support (22, 22a, 122) to a seat post tube (3) of a bicycle; and
a coupling portion (34, 34a, 134) configured to couple the support (22, 22a, 122) with a driving member (24) for actuating movement of a bicycle chain between different sprockets that drive the bicycle chain;
wherein the anchoring portion (32, 132) is structurally distinct from the coupling portion (34, 34a, 134) and is composed of reinforced composite material.

41. A support (22, 22a, 122) for a bicycle front gearshift (20, 120), comprising:
an anchoring portion (32, 132) configured to anchor the support to a seat post tube (3) of a bicycle; and
a coupling portion (34, 34a, 134) configured to couple the support with a cage (24) of a bicycle chain;
wherein the anchoring portion (32, 132) is structurally distinct from the coupling portion (34, 34a, 134) and comprises at least one connecting part (33, 133) for connecting to the coupling portion (34, 134), at least the connecting part (33, 133) being composed of a material having thermal expansion coefficient less than or equal to 5·10⁻⁵ m/m-K.

42. A support (22, 22a, 122) for a bicycle gearshift (20, 120) comprising an anchoring portion (32, 132); a coupling portion (34, 34a, 134) for coupling with a driving member (24) of a bicycle chain; and at least one connector that rigidly joins the anchoring and coupling portions while preserving the anchoring portion (32, 132) as a distinct structure from the coupling portion (34, 34a, 134).

43. A bicycle gearshift (20, 120) support (22, 22a, 122) comprising an anchoring portion (32, 132) for anchoring to an element of a bicycle frame, and a coupling portion (34, 34a, 134) for coupling with a driving member (24) of a bicycle chain, wherein the anchoring portion (32, 132) and the coupling portion (34, 34a, 134) are structurally distinct from each other and rigidly joined by a connector.

44. A support (22, 22a, 122) for a bicycle gearshift (20, 120) comprising an anchoring portion (32, 132); a coupling portion (34, 34a, 134) configured to couple with a driving member (24) of a bicycle chain; and a connector that rigidly joins the anchoring and coupling portions together.

45. A bicycle gearshift (20, 120) support (22, 22a, 122) characterized by structurally distinct anchoring (32, 132) and coupling (34, 134a, 134) portions that are rigidly joined together by a connector.
